(19) United States
(12) Patent Application Publication
(10) Pub. No.: US 2026/0196526 A1
(43) Pub. Date: Jul. 9, 2026

(54) SOLID ELECTROCHEMICAL DEVICE

(71) Applicant: SUMITOMO ELECTRIC INDUSTRIES, LTD., Osaka-shi, Osaka (JP)

(72) Inventors: Koma NUMATA, Osaka-shi (JP); Akihisa HOSOE, Osaka-shi (JP)

(73) Assignee: SUMITOMO ELECTRIC INDUSTRIES, LTD., Osaka-shi, Osaka (JP)

(21) Appl. No.: 19/133,303

(22) PCT Filed: Sep. 15, 2023
(86) PCT No.: PCT/JP2023/033657

§ 371 Date: May 28, 2025

(30) Foreign Application Priority Data
Jan. 10, 2023 (JP) 2023-001579

(51) Int. Cl. H01M 8/0232; C25B 9/17; C25B 9/65; C25B 13/02; C25B 13/05; H01M 8/0247; H01M 8/12

(52) U.S. Cl. CPC H01M 8/0232; C25B 9/17; C25B 9/65; C25B 13/02; C25B 13/05; H01M 8/0247; H01M 8/12; H01M 2008/1293

(57) ABSTRACT

A solid electrochemical device comprising a solid electrolyte having a first main surface and a second main surface that is a surface opposite to the first main surface; a first electrode having a third main surface and a fourth main surface that is a surface opposite to the third main surface, the first electrode being provided such that the third main surface faces the first main surface; a first current collector having a fifth main surface and a sixth main surface that is a surface opposite to the fifth main surface, the first current collector being provided such that the fifth main surface faces the fourth main surface; and a first interconnector having a seventh main surface, the first interconnector being provided such that the seventh main surface faces the sixth main surface. The seventh main surface of the first interconnector is a flat surface.

### TECHNICAL FIELD

The present disclosure relates to a solid electrochemical device. This application claims priority based on Japanese Patent Application No. 2023-001579 filed on Jan. 10, 2023, the entire contents of which are incorporated herein by reference.

### BACKGROUND ART

Conventionally, a solid electrochemical device has been used which includes a solid electrolyte having a first main surface and a second main surface that is a surface opposite to the first main surface, a first electrode having a third main surface and a fourth main surface that is a surface opposite to the third main surface and being provided such that the third main surface faces the first main surface, a first current collector having a fifth main surface and a sixth main surface that is a surface opposite to the fifth main surface and being provided such that the fifth main surface faces the fourth main surface, and a first interconnector having a seventh main surface and being provided such that the seventh main surface faces the sixth main surface (Patent Literature 1).

### CITATION LIST

### Patent Literature

Patent Literature 1: WO 2021/210231

### SUMMARY OF INVENTION

A solid electrochemical device according to an aspect of the present disclosure includes a solid electrolyte having a first main surface and a second main surface that is a surface opposite to the first main surface; a first electrode having a third main surface and a fourth main surface that is a surface opposite to the third main surface, and being provided such that the third main surface faces the first main surface; a first current collector having a fifth main surface and a sixth main surface that is a surface opposite to the fifth main surface, and being provided such that the fifth main surface faces the fourth main surface; and a first interconnector having a seventh main surface and being provided such that the seventh main surface faces the sixth main surface. The seventh main surface of the first interconnector is a flat surface. The first current collector is formed of a first metal porous body having a three-dimensional network structure. A plurality of first through holes extending along a first direction from the fifth main surface toward the sixth main surface are formed in the fifth main surface.

### BRIEF DESCRIPTION OF THE DRAWINGS

FIG. 1 is a schematic cross-sectional view illustrating an example of a solid electrochemical device according to an embodiment of the present disclosure.

FIG. 2 is a schematic plan view illustrating an example of a first current collector according to an embodiment of the present disclosure.

### DETAILED DESCRIPTION

### Problems to be Solved by the Present Disclosure

Conventionally, in a solid electrochemical device, an interconnector subjected to groove processing has been used in combination with a current collector formed of a metal porous body having a three-dimensional network structure. For this reason, the grooves of the interconnector make it difficult for “pressure loss” to occur in the solid electrochemical device, and allow a fuel gas or air to diffuse easily in the current collector.

In recent years, there has been a growing demand for miniaturization of the solid electrochemical device. For example, as a method for miniaturizing the solid electrochemical device, it is conceivable to use an interconnector which is made thinner by having no grooves in the main surface and having a flat main surface. However, when the interconnector having a reduced thickness is used in combination with the current collector, the “pressure loss” in the solid electrochemical device may increase, and the “power density” of the solid electrochemical device may be easily reduced due to a decrease in gas diffusibility. Thus, in some cases, it is difficult to make the solid electrochemical device “compact”, to suppress the “pressure loss”, and to suppress a decrease in the “power density”.

An object of the present disclosure is to provide a solid electrochemical device that is compact, is excellent in suppressing “pressure loss”, and has an excellent “power density”.

### Advantageous Effects of Present Disclosure

According to the present disclosure, it is possible to provide a solid electrochemical device that is compact, is excellent in suppression of “pressure loss”, and has an excellent “power density”

### Description of Embodiments of Present Disclosure

First, embodiments of the present disclosure will be listed and described.
[1] A solid electrochemical device according to an aspect of the present disclosure includes a solid electrolyte having a first main surface and a second main surface that is a surface opposite to the first main surface; a first electrode having a third main surface and a fourth main surface that is a surface opposite to the third main surface, and being provided such that the third main surface faces the first main surface; a first current collector having a fifth main surface and a sixth main surface that is a surface opposite to the fifth main surface, and being provided such that the fifth main surface faces the fourth main surface; and a first interconnector having a seventh main surface and being provided such that the seventh main surface faces the sixth main surface. The seventh main surface of the first interconnector is a flat surface. The first current collector is formed of a first metal porous body having a three-dimensional network structure. A plurality of first through holes extending along a first direction from the fifth main surface toward the sixth main surface are formed in the fifth main surface.

According to the present disclosure, it is possible to provide a solid electrochemical device that is compact, is excellent in suppression of “pressure loss”, and has an excellent “power density”.
[2] In the above [1], in plan view of the fifth main surface, the first through holes each may have a first width along a second direction orthogonal to the first direction and each may have a second width along a third direction orthogonal to the first direction and the second direction. An average value of the first width and the second width may be 2 mm to 20 mm. This makes it possible to provide a solid electrochemical device that is more excellent in suppressing the “pressure loss” and has a more excellent “power density”.
[3] In the above [1] or [2], a first aperture ratio that is a percentage of a total area of the first through holes relative to an area of the fifth main surface may be 2.0% to 35%. This makes it possible to provide a solid electrochemical device that is more excellent in suppressing the “pressure loss” and has a more excellent “power density”.
[4] In any one of the above [1] to [3], in each of nine first regions set by equally dividing the fifth main surface into nine parts based on an area criterion, a second aperture ratio that is a percentage of a total area of the first through holes in each of the first regions relative to an area of each of the first regions may be 2.0% to 35%. This makes it possible to provide a solid electrochemical device that is more excellent in suppressing the “pressure loss” and has a more excellent “power density”.
[5] In any one of the above [1] to [4], the first metal porous body may be a nickel-cobalt metal porous body. This makes it possible to provide a solid electrochemical device having a more excellent “power density”.
[6] In any one of the above [1] to [4], the first metal porous body may be a nickel metal porous body. This makes it possible to provide a solid electrochemical device having a more excellent “power density”.
[7] In any one of the above [1] to [4], the first metal porous body may be a nickel-tin metal porous body. This makes it possible to provide a solid electrochemical device having a more excellent “power density”.
[8] In any one of the above [1] to [7], the solid electrochemical device may further include a second electrode having an eighth main surface and a ninth main surface that is a surface opposite to the eighth main surface, and being provided such that the eighth main surface faces the second main surface; a second current collector having a tenth main surface and an eleventh main surface that is a surface opposite to the tenth main surface, and being provided such that the tenth main surface faces the ninth main surface; and a second interconnector having a twelfth main surface and being provided such that the twelfth main surface faces the eleventh main surface. The twelfth main surface of the second interconnector may be a flat surface. The second current collector may be formed of a second metal porous body having a three-dimensional network structure. A plurality of second through holes extending along a fourth direction from the tenth main surface toward the eleventh main surface may be formed in the tenth main surface. This makes it possible to provide a solid electrochemical device that is more compact, is more excellent in suppressing “the pressure loss”, and has a more excellent “power density”.
[9] In the above [8], in plan view of the tenth main surface, the second through holes each may have a third width along a fifth direction orthogonal to the fourth direction and each may have a fourth width along a sixth direction orthogonal to the fourth direction and the fifth direction. An average value of the third width and the fourth width may be 2 mm to 20 mm. This makes it possible to provide a solid electrochemical device that is more excellent in suppressing the “pressure loss” and has a more excellent “power density”.
[10] In the above [8] or [9], a third aperture ratio that is a percentage of a total area of the second through holes relative to an area of the tenth main surface may be 2.0% to 35%. This makes it possible to provide a solid electrochemical device that is more excellent in suppressing the “pressure loss” and has a more excellent “power density”.
[11] In any one of the above [8] to [10], in each of nine second regions set by equally dividing the tenth main surface into nine parts based on an area criterion, a fourth aperture ratio that is a percentage of a total area of the second through holes in each of the second regions to an area of each of the second regions may be 2.0% to 35%. This makes it possible to provide a solid electrochemical device that is more excellent in suppressing the “pressure loss” and has a more excellent “power density”.
[12] In any one of the above [8] to [11], the second metal porous body may be a nickel-cobalt metal porous body. This makes it possible to provide a solid electrochemical device having a more excellent “power density”.
[13] In any one of the above [8] to [11], the second metal porous body may be a nickel metal porous body. This makes it possible to provide a solid electrochemical device having a more excellent “power density”.
[14] In any one of the above [8] to [11], the second metal porous body may be a nickel-tin metal porous body. This makes it possible to provide a solid electrochemical device having a more excellent “power density”.

### Details of Embodiments of Present Disclosure

Hereinafter, specific examples of a solid electrochemical device according to an embodiment (hereinafter also referred to as “the present embodiment”) of the present disclosure will be described with reference to the drawings. In the drawings of the present disclosure, elements having the same reference numerals designate the same or corresponding elements. Dimensions such as length, width, thickness, and depth are appropriately changed for the sake of clarity and simplification of the drawings, and do not necessarily represent actual dimensions.

In this specification, the notation in the form of “A to B” means a lower limit and an upper limit of a range (that is, A or more and B or less), and when there is no description of a unit for A and a unit is described only for B, the unit of A and the unit of B are the same.

### Embodiment 1: Solid Electrochemical Device

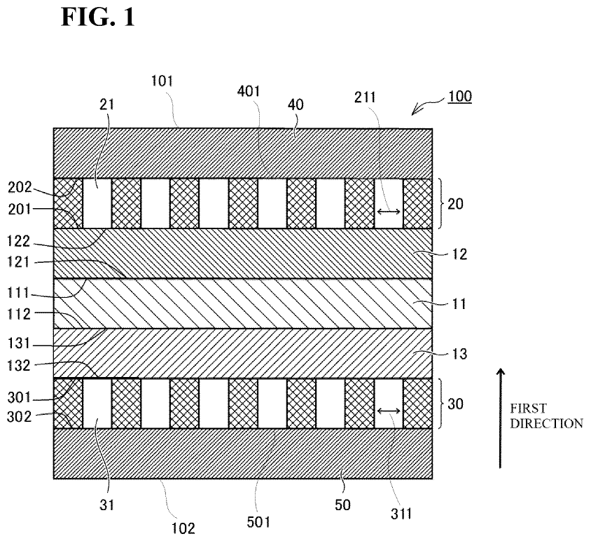

A solid electrochemical device according to an embodiment of the present disclosure will be described with reference to FIG. 1. FIG. 1 is a schematic cross-sectional view illustrating an example of a solid electrochemical device according to an embodiment of the present disclosure.

A solid electrochemical device 100 according to an embodiment (hereinafter also referred to as “Embodiment 1”) of the present disclosure includes a solid electrolyte 11 having a first main surface 111 and a second main surface 112 that is a surface opposite to the first main surface 111; a first electrode 12 having a third main surface 121 and a fourth main surface 122 that is a surface opposite to the third main surface 121, and being provided such that the third main surface 121 faces the first main surface 111; a first current collector 20 having a fifth main surface 201 and a sixth main surface 202 that is a surface opposite to the fifth main surface 201, and being provided such that the fifth main surface 201 faces the fourth main surface 122; and a first interconnector 40 having a seventh main surface 401 and being provided such that the seventh main surface 401 faces the sixth main surface 202. The seventh main surface 401 of the first interconnector 40 is a flat surface. The first current collector 20 is formed of a first metal porous body having a three-dimensional network structure. A plurality of first through holes 21 extending along a first direction from the fifth main surface 201 toward the sixth main surface 202 are formed in the fifth main surface.

According to the present disclosure, it is possible to provide a solid electrochemical device that is compact, is excellent in suppression of “pressure loss”, and has an excellent “power density”. The reason for this is considered as follows.
(a) The seventh main surface 401 of the first interconnector 40 is a flat surface. This makes it possible to reduce the thickness of the first interconnector 40, and thus to reduce the size of the solid electrochemical device 100 as a whole.
(b) As described above, the seventh main surface 401 of the first interconnector 40 is a flat surface, and thus the solid electrochemical device 100 can be miniaturized as a whole. However, in a case in which the seventh main surface 401 of the first interconnector 40 is a flat surface (in other words, the seventh main surface of the first interconnector 40 has no grooves), the “pressure loss” of the solid electrochemical device 100 tends to occur. In addition, the diffusibility of a fuel gas (hydrogen gas) and air in the current collector tends to decrease, and the reactivity of the fuel gas (hydrogen gas) and the reactivity of air tend to decrease, which tends to easily cause a decrease in the power density of the solid electrochemical device 100.

In the first current collector 20 of the solid electrochemical device 100 according to the present embodiment, the plurality of first through holes 21 extending along the first direction from the fifth main surface 201 toward the sixth main surface 202 are formed in the fifth main surface 201. This suppresses an increase in the “pressure loss”. In addition, the gas (fuel gas or air) flowing into the solid electrochemical device 100 from a side of the solid electrochemical device 100 on which the first interconnector 40 is present is easily diffused in the first current collector 20, and thus, a decrease in the “diffusibility” of the fuel gas or air is suppressed, and a decrease in the power density of the solid electrochemical device 100 can be suppressed.

That is, according to the present disclosure, it is possible to provide the solid electrochemical device 100 that is compact, is excellent in suppressing the “pressure loss”, and has an excellent “power density”.

### <<Solid Electrochemical Device>>

In the present disclosure, the solid electrochemical device 100 is a concept including both a solid oxide fuel cell (SOFC) and a solid oxide electrolysis cell (SOEC). In the present disclosure, the solid electrochemical device 100 can be considered to have a sheet shape and include a thirteenth main surface 101 and a fourteenth main surface 102.

The solid electrochemical device 100 may have a thickness of 2.1 mm or less. Here, the thickness of the solid electrochemical device 100 means a distance between the thirteenth main surface 101 and the fourteenth main surface 102. Thus, it is possible to provide the solid electrochemical device 100 that is compact. An upper limit of the thickness of the solid electrochemical device 100 may be 1.8 mm or 1.5 mm. A lower limit of the thickness of the solid electrochemical device 100 is not particularly limited, and may be 1 mm, 0.75 mm, or 0.5 mm from the viewpoint of production.

The thickness of the solid electrochemical device 100 can be determined by the same method as the method for measuring the “thickness of the first current collector 20” described later.

### <<Solid Electrolyte>>

The solid electrochemical device 100 of the present disclosure includes the solid electrolyte 11 having the first main surface 111 and the second main surface 112 that is a surface opposite to the first main surface 111. For example, the solid electrolyte 11 is formed of yttria-stabilized zirconium (YSZ).

The solid electrolyte 11 may have a thickness of 0.0005 mm to 0.05 mm. When the thickness of the solid electrolyte 11 is less than 0.0005 mm, the solid electrolyte 11 tends to become difficult to function as a solid electrolyte in the solid electrochemical device 100. When the thickness of the solid electrolyte 11 is more than 0.05 mm, the solid electrochemical device 100 tends to become difficult to reduce the size. The thickness of the solid electrolyte 11 can be determined by the same method as the method for measuring the “thickness of the first current collector 20” described later.

### <<First Electrode>>

The solid electrochemical device 100 of the present disclosure includes the first electrode 12 having the third main surface 121 and the fourth main surface 122 that is a surface opposite to the third main surface 121, and being provided such that the third main surface 121 faces the first main surface 111. The first electrode 12 may be a cathode or may be an anode. However, when the first electrode 12 is a cathode, a second electrode 13 described later is an anode. When the first electrode 12 is an anode, the second electrode 13 described later is a cathode. When the first electrode 12 is a cathode, the first electrode 12 may be formed of, for example, LSC (lanthanum (La)-strontium (Sr)-cobalt (Co) oxide). When the first electrode 12 is an anode, the first electrode 12 may be formed of, for example, a composite of YSZ and nickel oxide (Ni₂O).

The first electrode 12 may have a thickness of 0.1 mm to 0.5 mm. When the thickness of the first electrode 12 is less than 0.1 mm, the first electrode 12 tends to become difficult to function as an electrode in the solid electrochemical device 100. When the thickness of the first electrode 12 is more than 0.5 mm, the solid electrochemical device 100 tends to become difficult to reduce the size. The thickness of the first electrode 12 can be determined by the same method as the method for measuring the “thickness of the first current collector 20” described later.

### <<First Current Collector>

The solid electrochemical device 100 of the present disclosure includes the first current collector 20 having the fifth main surface 201 and a sixth main surface 202 that is a surface opposite to the fifth main surface 201, and being provided such that the fifth main surface 201 faces the fourth main surface 122. With regard to the first current collector 20, except as described below, the contents described in paragraphs to [0047], paragraphs to [0084], paragraph [0086], paragraph [0087], and paragraphs to of International Publication WO 2021/153406 are incorporated in the present specification by reference. However, in the present disclosure, the description “bubbles are easily released to the outside” in the above contents is read as “diffusibility of gas is easily improved and pressure loss is easily suppressed”. In the present disclosure, the term “metal porous body sheet” in the above contents is read as the term “first current collector”. In the present disclosure, the term “hole” in the above contents is read as the term “first through hole”. In the present disclosure, the term “first main surface” in the above contents is read as the term “fifth main surface”, and the term “second main surface” in the above contents is read as the term “sixth main surface”. In the present disclosure, the term “width W1” in the above contents is read as the term “first width”, and the term “width W2” in the above contents is read as the term “second width”. In the present disclosure, the term “aperture ratio” in the above contents is read as the term “first aperture ratio”.

The first current collector 20 may have a thickness of 0.05 mm to 0.5 mm. When the thickness of the first current collector 20 is less than 0.05 mm, the first current collector 20 tends to become difficult to function as a current collector in the solid electrochemical device 100. When the thickness of the first current collector 20 is more than 0.5 mm, the solid electrochemical device 100 tends to become difficult to reduce the size. The thickness of the first current collector 20 can be measured with a commercially available digital thickness gauge (TECLOCK Co., Ltd.).

### <First Through Hole>

In the solid electrochemical device 100 of the present disclosure, the plurality of first through holes 21 extending along the first direction from the fifth main surface 201 toward the sixth main surface 202 are formed in the fifth main surface 201. This makes it possible to suppress the “pressure loss” and to improve the “power density” in the solid electrochemical device 100.

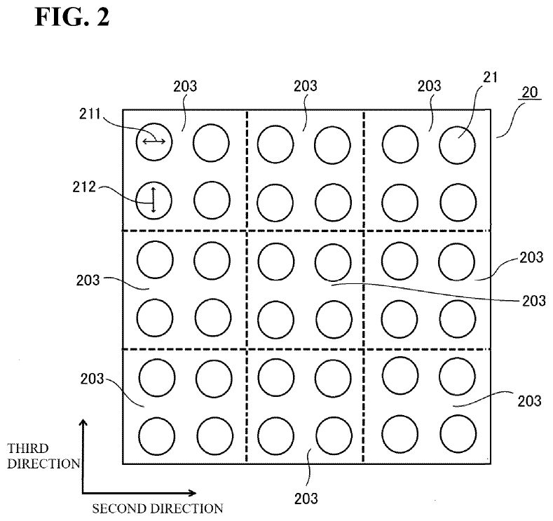

As illustrated in FIG. 2, in plan view of the fifth main surface 201, the first through holes 21 each may have a first width 211 along a second direction orthogonal to the first direction and each may have a second width 212 along a third direction orthogonal to the first direction and the second direction. An average value of the first width 211 and the second width 212 may be 2 mm to 20 mm. The second direction is a direction in which the first width 211 is maximized. This makes it possible to further suppress an increase in pressure loss and a decrease in power density. A lower limit of the average value of the first width 211 and the second width 212 may be 2 mm, 4 mm, or 5 mm. An upper limit of the average value of the first width 211 and the second width 212 may be 20 mm, 15 mm, or 10 mm. The average value of the first width 211 and the second width 212 may be 4 mm to 15 mm, or may be 5 mm to 10 mm.

In the solid electrochemical device 100, the average value of the first width 211 and the second width 212 can be determined by the following method. That is, in plan view of the fifth main surface 201 of the first current collector 20, the first width 211 and the second width 212 are measured for any one of first through holes 21. Next, the sum of the first width 211 and the second width 212 is divided by two to obtain a numerical value. Next, numerical values are obtained for any other four of first through holes 21 by the same method. By calculating the average value of these numerical values, the average value of the first width 211 and the second width 212 can be determined.

In the fifth main surface 201, a first aperture ratio of the first through holes 21 may be 2.0% to 35%. The first aperture ratio is a percentage of the total area S1 of the first through holes 21 relative to an area S2 of the fifth main surface 201. This makes it possible to further suppress an increase in pressure loss and a decrease in power density. A lower limit of the first aperture ratio of the first through holes 21 may be 2.0%, 5%, or 10%. An upper limit of the first aperture ratio of the first through holes 21 may be 35%, 30%, or 25%. The first aperture ratio of the first through holes 21 may be 5% to 30%, or may be 10% to 25%.

In the first current collector 20, the area S1 of the first through holes 21 and the area S2 of the fifth main surface 201 can be determined by the following method. First, the fifth main surface 201 of the first current collector 20 is photographed from the first direction, thereby obtaining image data of the fifth main surface 201 of the first current collector 20. Next, binarization processing is performed on the image data to identify regions where the first through holes 21 are formed and the other region. Next, the area S1 of the first through holes 21 can be obtained by measuring areas of the regions where the first through holes 21 are formed. The area S2 of the fifth main surface 201 can be obtained by measuring an area of a region obtained by combining the “regions where the first through holes 21 are formed” and the “other region”.

In each of nine first regions 203 set by equally dividing the fifth main surface 201 into nine parts based on an area criterion, a second aperture ratio of the first through holes 21 may be 2.0% to 35%. Here, the second aperture ratio is a percentage of the total area S1 of the first through holes 21 in each of the first regions 203 relative to the area S3 of each of the first regions 203. This makes it possible to further suppress an increase in pressure loss and a decrease in power density. In each of the nine first regions 203, the second aperture ratio of the first through holes 21 may be 2.0% or more, 5% or more, or 10% or more. In each of the nine first regions 203, the second aperture ratio of the first through holes 21 may be 35% or less, 30% or less, or 25% or less. In each of the nine first regions 203, the second aperture ratio of the first through holes 21 may be 5% to 30%, or 10% to 25%.

The area S3 of the first regions 203 of the first current collector 20 can be determined by the same method as that for the area S2 of the fifth main surface 201 except that the first regions 203 are set by dividing the image data of the fifth main surface 201 of the first current collector 20 into nine equal parts based on an area criterion. When the first through hole 21 is located across the plurality of first regions 203, only the area of a portion located within a first region to be measured of the first regions 203 is measured.

In the first current collector 20, the plurality of first through holes 21 may be arranged in a plurality of lines along the second direction. The plurality of first through holes 21 included in each of the plurality of lines may be periodically arranged at a first interval in the second direction. Each of the plurality of lines may be arranged periodically at a second interval in the third direction.

### <First Metal Porous Body>

The first current collector 20 is formed of a first metal porous body having a three-dimensional network structure. The term “first metal porous body” means a porous body whose skeleton body contains a metal element as a main component. Here, the expression “the skeleton body contains a metal element as a main component” means that the total content of metal elements in the skeleton body exceeds 50% by mass.

In the skeleton body, the “total content of metal elements” can be determined by the following procedure. First, a portion where the skeleton extends is identified, and an observation image of a cross section perpendicular to an extending direction of the skeleton is obtained by an electron microscope (SEM). Next, the observed portion is analyzed using an EDX apparatus attached to the SEM. As the SEM, for example, a product available under the trade name “SUPRA35VP” from Carl Zeiss Microscopy Co., Ltd. is used. As the EDX apparatus, for example, “octane super” (trade name) manufactured by AMETEK, Inc. is used. A mass percentage of each of the metal elements in the skeleton body is determined based on an atomic concentration of each of elements detected by the EDX apparatus. Next, the “total content of metal elements” in the skeleton body can be determined by summing the “mass percentage of each of the metal elements in the skeleton body”.

It has been confirmed that there is no variation in the measurement results even when the measurement region is arbitrarily changed as long as the measurement is performed by the above-described method in the same first current collector 20.

The first metal porous body may be a nickel-cobalt metal porous body. This can further suppress a decrease in power density. The term “nickel-cobalt metal porous body” means a porous body whose skeleton body contains a nickel element and a cobalt element as main components. Here, the expression “the skeleton body contains a nickel element and a cobalt element as main components” means that the skeleton body contains both of a nickel element and a cobalt element, and the total content of the nickel element and the cobalt element exceeds 50% by mass.

The first metal porous body may be a nickel metal porous body. This can further suppress a decrease in power density. The term “nickel metal porous body” means a porous body whose skeleton body contains a nickel element as a main component. Here, the expression “the skeleton body contains a nickel element as a main component” means that the total content of the nickel element exceeds 50% by mass in the skeleton body.

The first metal porous body may be a nickel-tin metal porous body. This can further suppress a decrease in power density. The term “nickel-tin metal porous body” means a porous body whose skeleton body contains a nickel element and a tin element as main components. Here, the expression “the skeleton body contains a nickel element and a tin element as main components” means that the skeleton body contains both of a nickel element and a tin element, and the total content of the nickel element and the tin element exceeds 50% by mass.

An average pore diameter of the first metal porous body is not particularly limited, and may be, for example, 100 μm to 1000 μm, 200 μm to 900 μm, or 400 μm to 800 μm. With regard to the average pore diameter, the contents described in International Publication WO 2021/153406 are incorporated in the present specification by reference.

### <<First Interconnector>>

The solid electrochemical device 100 of the present disclosure includes the first interconnector 40 having the seventh main surface 401 and being provided such that the seventh main surface 401 faces the sixth main surface 202. The seventh main surface 401 of the first interconnector 40 is a flat surface. Here, the expression “the seventh main surface 401 is a flat surface” means that “no groove is formed in the seventh main surface 401”. This makes it possible to reduce the thickness of the first interconnector 40 and to reduce the size of the solid electrochemical device 100. For example, the first interconnector 40 is formed of an iron-chromium (FeCr) alloy.

The first interconnector 40 may have a thickness of 0.1 mm to 0.4 mm. When the thickness of the first interconnector 40 is less than 0.1 mm, the first interconnector 40 tends to become difficult to function as an interconnector in the solid electrochemical device 100. When the thickness of the first interconnector 40 is more than 0.4 mm, the solid electrochemical device 100 tends to become difficult to reduce the size. The thickness of the first interconnector 40 can be determined by the same method as the method for measuring the “thickness of the first current collector 20” described above.

### <<Second Electrode>>

The solid electrochemical device 100 of the present disclosure may further includes the second electrode 13 having an eighth main surface 131 and a ninth main surface 132 that is a surface opposite to the eighth main surface 131, and being provided such that the eighth main surface 131 faces the second main surface 112. When the second electrode 13 is a cathode, the second electrode 13 may be formed of, for example, LSC (lanthanum (La)-strontium (Sr)-cobalt (Co) oxide). When the second electrode 13 is an anode, the second electrode 13 may be formed of, for example, a composite of YSZ and nickel oxide (Ni₂O).

The second electrode 13 may have a thickness of 0.1 mm to 0.5 mm. When the thicknesses of the second electrode 13 are less than 0.1 mm, the second electrode 13 tends to become difficult to function as an electrode in the solid electrochemical device 100. When the thicknesses of the second electrode 13 is more than 0.5 mm, the solid electrochemical device 100 tends to become difficult to reduce the size. The thickness of the second electrode 13 can be determined by the same method as the method for measuring the “thickness of the first current collector 20” described above.

### <<Second Current Collector>>

The solid electrochemical device 100 of the present disclosure may further include a second current collector 30 having a tenth main surface 301 and an eleventh main surface 302 that is a surface opposite to the tenth main surface 301, and being provided such that the tenth main surface 301 faces the ninth main surface 132. With regard to the second current collector 30, except as described below, the contents described in paragraphs to [0047], paragraphs [0080] to [0084], paragraph [0086], paragraph [0087], and paragraphs to of International Publication WO 2021/153406 are incorporated in the present specification by reference. However, in the present disclosure, the description “bubbles are easily released to the outside” in the above contents is read as “diffusibility of gas is easily improved and pressure loss is easily suppressed”. In the present disclosure, the term “metal porous body sheet” in the above contents is read as the term “second current collector”. In the present disclosure, the term “hole” in the above contents is read as the term “second through hole”. In the present disclosure, the “first main surface” in above contents is read as the “tenth main surface”, and the “second main surface” in the above contents is read as the “eleventh main surface”. In the present disclosure, the “first direction” in the above contents is read as the “fourth direction”, the “second direction” in the above contents is read as the “fifth direction”, and the “third direction” in the above contents is read as the “sixth direction”. In the present disclosure, the term “width W1” in the above contents is read as the term “third width”, and the term “width W2” in the above contents is read as the term “fourth width”. In the present disclosure, the term “aperture ratio” in the above contents is read as the term “third aperture ratio”.

The second current collector 30 may have a thickness of 0.05 mm to 0.5 mm. When the thickness of the second current collector 30 is less than 0.05 mm, the second current collector 30 tends to become difficult to function as a current collector in the solid electrochemical device 100. When the thickness of the second current collector 30 is more than 0.5 mm, the solid electrochemical device 100 tends to become difficult to reduce the size. The thickness of the second current collector 30 can be determined by the same method as the method for measuring the “thickness of the first current collector 20” described above.

### <Second Through Hole>

In the solid electrochemical device 100 of the present disclosure, a plurality of second through holes 31 extending along a fourth direction from the tenth main surface 301 toward an eleventh main surface 302 may be formed in the tenth main surface 301, or may not be formed. In the solid electrochemical device 100 of the present disclosure, the plurality of second through holes 31 extending along the fourth direction from the tenth main surface 301 toward the eleventh main surface 302 may be formed in the tenth main surface 301. This makes it possible to further suppress an increase in pressure loss and a decrease in power density.

In plan view of the tenth main surface, the second through holes 31 each may have a third width 311 along a fifth direction orthogonal to the fourth direction and each may have a fourth width along a sixth direction orthogonal to the fourth direction and the fifth direction. An average value of the third width 311 and the fourth width may be 2 mm to 20 mm. The fifth direction is a direction in which the third width 311 is maximized. This makes it possible to further suppress an increase in pressure loss and a decrease in power density. A lower limit of the average value of the third width 311 and the fourth width may be 2 mm, 4 mm, or 5 mm. An upper limit of the average value of the third width 311 and the fourth width may be 20 mm, 15 mm, or 10 mm. The average value of the third width 311 and the fourth width may be 4 mm to 15 mm, or 5 mm to 10 mm.

In the solid electrochemical device 100, the average value of the third width 311 and the fourth width can be determined by the following method. That is, in plan view of the tenth main surface 301 of the second current collector 30, the third width 311 and the fourth width are measured for any one of second through holes 31. Next, the sum of the third width 311 and the fourth width is divided by two to obtain a numerical value. Next, numerical values are obtained for any other four of second through holes 31 by the same method. By calculating the average value of these numerical values, the average value of the third width 311 and the fourth width can be determined.

In the tenth main surface 301, a third aperture ratio of the second through holes 31 may be 2.0% to 35%. The third aperture ratio is a percentage of the total area S4 of the second through holes 31 relative to an area S5 of the tenth main surface 301. This makes it possible to further suppress an increase in pressure loss and a decrease in power density. A lower limit of the third aperture ratio of the second through holes 31 may be 2.0%, 5.0%, or 10%. An upper limit of the third aperture ratio of the second through holes 31 may be 35%, 30%, or 25%. The third aperture ratio of the second through holes 31 may be 5% to 30%, or may be 10% to 25%.

In the second current collector 30, the area S4 of the second through holes 31 and the area S5 of the tenth main surface 301 can be determined by the following method. First, the tenth main surface 301 of the second current collector 30 is photographed from the fourth direction, thereby obtaining image data of the tenth main surface 301 of the second current collector 30. Next, binarization processing is performed on the image data to identify regions where the second through holes 31 are formed and the other region. Next, the area S4 of the second through holes 31 can be obtained by measuring areas of the regions where the second through holes 31 are formed. The area S5 of the tenth main surface 301 can be obtained by measuring an area of a region obtained by combining the “regions where the second through holes 31 are formed” and the “other region”.

In each of nine second regions set by equally dividing the tenth main surface 301 into nine parts based on an area criterion, a fourth aperture ratio of the second through holes 31 may be 2.0% to 35%. Here, the fourth aperture ratio is a percentage of the total area S4 of the second through holes 31 in each of the second regions relative to the area S6 of each of the second regions. This makes it possible to further suppress an increase in pressure loss and a decrease in power density. In each of the nine second regions, the fourth aperture ratio of the second through holes 31 may be 2.0% or more, 5% or more, or 10% or more. In each of the nine second regions, the fourth aperture ratio of the second through holes 31 may be 35% or less, 30% or less, or 25% or less. In each of the nine second regions, the fourth aperture ratio of the second through holes 31 may be 5% to 30%, or may be 10% to 25%.

The area S6 of the second regions of the second current collector 30 can be determined by the same method as that for the area S5 of the tenth main surface 301 except that the second regions are set by dividing the image data of the tenth main surface 301 of the second current collector 30 into nine equal parts based on an area criterion. When the second through holes 31 is located across the plurality of second regions, only the area of a portion located within a second region to be measured of the second regions is measured.

In the second current collector 30, the plurality of second through holes 31 may be arranged in a plurality of lines along the fifth direction. The plurality of second through holes 31 included in each of the plurality of lines may be periodically arranged at a third interval in the fifth direction. Each of the multiple lines may be arranged periodically at a fourth interval in the sixth direction.

### <Second Metal Porous Body>

The second current collector 30 may be formed of a second metal porous body having a three-dimensional network structure. The term “second metal porous body” means a porous body whose skeleton body contains a metal element as a main component. Here, the expression “the skeleton body contains a metal element as a main component” means that the total content of metal elements in the skeleton body exceeds 50% by mass. The “total content of metal elements” in the skeleton body can be determined by the same procedure as in the measurement of the “total content of metal elements” in the “first metal porous body”.

It has been confirmed that there is no variation in the measurement results even when the measurement region is arbitrarily changed as long as the measurement is performed by the above-described method in the same second current collector 30.

The second metal porous body may be a nickel-cobalt metal porous body. This can further suppress a decrease in power density. The definition of the nickel-cobalt metal porous body is the same as that of the nickel-cobalt metal porous body according to the first metal porous body.

The second metal porous body may be a nickel metal porous body. This can further suppress a decrease in power density. The definition of the nickel metal porous body is the same as that of the nickel metal porous body according to the first metal porous body.

The second metal porous body may be a nickel-tin metal porous body. This can further suppress a decrease in power density. The definition of the nickel-tin metal porous body is the same as that of the nickel-tin metal porous body according to the first metal porous body.

An average pore diameter of the second metal porous body is not particularly limited, and may be, for example, 100 μm to 1000 μm, 200 μm to 900 μm, or 400 μm to 800 μm. With regard to the average pore diameter, the contents of International Publication WO 2021/153406 are incorporated in the present specification by reference.

### <<Second Interconnector>>

The solid electrochemical device 100 of the present disclosure may further include a second interconnector 50 having a twelfth main surface 501 and being provided such that the twelfth main surface 501 faces the eleventh main surface 302. For example, the second interconnector 50 is formed of an iron-chromium (FeCr) alloy. In addition, the twelfth main surface of the second interconnector 50 may be a flat surface or may not be a flat surface. Here, the expression “the twelfth main surface 501 is a flat surface” means that “no groove is formed in the twelfth main surface 501”. The twelfth main surface 501 of the second interconnector 50 may be a flat surface. This makes it possible to further reduce the size of the solid electrochemical device 100.

The second interconnector 50 may have a thickness of 0.1 mm to 0.4 mm. When the thickness of the second interconnector 50 is less than 0.1 mm, the second interconnector 50 tends to become difficult to function as an interconnector in the solid electrochemical device 100. When the thickness of the second interconnector 50 is more than 0.4 mm, the solid electrochemical device 100 tends to become difficult to reduce the size. The thickness of the second interconnector 50 can be determined by the same method as the method for measuring the “thickness of the first current collector 20” described above.

### <<Cell>>

In the present disclosure, a structure including the solid electrolyte 11, the first electrode 12, and the second electrode 13 is defined as a cell. The cell may have a thickness of 0.2005 mm to 1.05 mm. When the thickness of the cell is less than 0.2005 mm, the cell tends to become difficult to function as a cell in the solid electrochemical device 100. When the thickness of the cell is more than 1.05 mm, the solid electrochemical device 100 tends to become difficult to reduce the size. A lower limit of the thickness of the cell may be 0.25 mm, 0.3 mm, or 0.35 mm. An upper limit of the thickness of the cell may be 0.9 mm, 0.8 mm, or 0.7 mm. The thickness of the cell may be 0.3 mm to 0.8 mm, or may be 0.35 mm to 0.7 mm.

In the solid electrochemical device 100, the thickness of the cell can be determined by calculating the sum of the “thickness of the solid electrolyte 11”, the “thickness of the first electrode 12”, and the “thickness of the second electrode 13”

### <<Method for Manufacturing Solid Electrochemical Device>>

The solid electrochemical device 100 according to the present embodiment can be manufactured by using a known method as appropriate.

### Example

The method for manufacturing the solid electrochemical device 100 will be described specifically based on an example in the present disclosure, but the present invention is not limited to the following example.

### <<Fabrication of Solid Electrochemical Device>>

First, in order to fabricate solid electrochemical devices for sample 1 to sample 12, sample 101, and sample 102, the first interconnectors listed in Table 1, the first current collectors listed in Table 1, the first electrodes listed in Table 1, the solid electrolytes listed in Table 1, the second electrodes listed in Table 1, the second current collectors listed in Table 1, and the second interconnectors listed in Table 1 were prepared. The flat surface dimensions of the first interconnectors, the first current collectors, the first electrodes, the solid electrolytes, the second electrodes, the second current collectors, and the second interconnectors were all 100 mm×100 mm. The description “FeCr” in the “Composition” column of the “First interconnector” column in Table 1 means that the first interconnector of the sample is formed of an iron-chromium (FeCr) alloy. The description “NiCo” in the “Composition” column of the “First current collector” column in Table 1 means that the first current collector of the sample is formed of a nickel-cobalt (NiCo) metal porous body. The description “LSC” in the “Composition” column of the “First electrode” column in Table 1 means that the first electrode of the sample is formed of LSC (lanthanum (La)-strontium (Sr)-cobalt (Co) oxide). The description “YSZ” in the “Composition” column of the “Solid electrolyte” column in Table 1 means that the solid electrolyte of the sample is formed of yttria-stabilized zirconium (YSZ). The description “Ni+YSZ” in the “Composition” column of the “Second electrode” column in Table 1 means that the second electrode of the sample is formed of a composite of YSZ and nickel oxides (Ni₂O). The description “Ni” in the “Composition” column of the “Second current collector” column in Table 1 means that the second current collector of the sample is formed of a nickel metal porous body. The description “FeCr” in the “Composition” column of the “Second interconnector” column in Table 1 means that the second interconnector of the sample is formed of an iron-chromium (FeCr) alloy.

Next, the solid electrochemical devices for sample 1 to sample 12, sample 101, and sample 102 were fabricated by using a known method except that the first interconnectors listed in Table 1, the first current collectors listed in Table 1, the first electrodes listed in Table 1, the solid electrolytes listed in Table 1, the second electrodes listed in Table 1, the second current collectors listed in Table 1, and the second interconnectors listed in Table 1 were combined.

TABLE 1

| | | | Sample No. | | | | | | | | | | | | | |
|---|---|---|---|---|---|---|---|---|---|---|---|---|---|---|---|---|
| | | | 101 | 102 | 1 | 2 | 3 | 4 | 5 | 6 | 7 | 8 | 9 | 10 | 11 | 12 |
| First | Groove | | Present | None | None | None | None | None | None | None | None | None | None | None | None | None |
| inter- | Composition | | FeCr | FeCr | FeCr | FeCr | FeCr | FeCr | FeCr | FeCr | FeCr | FeCr | FeCr | FeCr | FeCr | FeCr |
| connector | Thickness [mm] | | 0.5 | 0.1 | 0.1 | 0.1 | 0.1 | 0.1 | 0.1 | 0.1 | 0.1 | 0.1 | 0.1 | 0.1 | 0.1 | 0.1 |
| First | First | Number | 0 | 0 | 2 or more | 2 or more | 2 or more | 2 or more | 2 or more | 2 or more | 2 or more | 2 or more | 2 or more | 2 or more | 2 or more | 2 or more |
| current | through | of holes | | | | | | | | | | | | | | |
| collector | hole | {(First | — | — | 5 | 5 | 5 | 5 | 5 | 5 | 5 | 10 | 20 | 2 | 1 | 30 |
| | | width) + | | | | | | | | | | | | | | |
| | | (Second | | | | | | | | | | | | | | |
| | | width)}/2 | | | | | | | | | | | | | | |
| | | [mm] | | | | | | | | | | | | | | |
| | | First | — | — | 5 | 6.3 | 7.5 | 15 | 26 | 30 | 2 | 10 | 20 | 2 | 1 | 30 |
| | | interval | | | | | | | | | | | | | | |
| | | [mm] | | | | | | | | | | | | | | |
| | | Second | — | — | 5 | 6.3 | 7.5 | 15 | 26 | 30 | 2 | 10 | 20 | 2 | 1 | 30 |
| | | interval | | | | | | | | | | | | | | |
| | | [mm] | | | | | | | | | | | | | | |
| | First aperture ratio [%] | | 0 | 0 | 20 | 15 | 13 | 5.0 | 2.0 | 1.6 | 40 | 20 | 20 | 20 | 20 | 20 |
| | Second | Maximum | 0 | 0 | 20 | 15 | 13 | 5.0 | 2.0 | 1.6 | 40 | 20 | 20 | 20 | 20 | 20 |
| | aperture | Minimum | 0 | 0 | 20 | 15 | 13 | 5.0 | 2.0 | 1.6 | 40 | 20 | 20 | 20 | 20 | 20 |
| | ratio [%] | | | | | | | | | | | | | | | |
| | Average pore diameter | | 450 | 450 | 450 | 450 | 450 | 450 | 450 | 450 | 450 | 450 | 450 | 450 | 450 | 450 |
| | of first metal porous | | | | | | | | | | | | | | | |
| | body [μm] | | | | | | | | | | | | | | | |
| | Composition | | NiCo | NiCo | NiCo | NiCo | NiCo | NiCo | NiCo | NiCo | NiCo | NiCo | NiCo | NiCo | NiCo | NiCo |
| | Thickness [mm] | | 0.5 | 0.5 | 0.5 | 0.5 | 0.5 | 0.5 | 0.5 | 0.5 | 0.5 | 0.5 | 0.5 | 0.5 | 0.5 | 0.5 |
| Cell | First | Compo- | LSC | LSC | LSC | LSC | LSC | LSC | LSC | LSC | LSC | LSC | LSC | LSC | LSC | LSC |
| | electrode | sition | | | | | | | | | | | | | | |
| | Solid | Compo- | YSZ | YSZ | YSZ | YSZ | YSZ | YSZ | YSZ | YSZ | YSZ | YSZ | YSZ | YSZ | YSZ | YSZ |
| | electrolyte | sition | | | | | | | | | | | | | | |
| | Second | Compo- | Ni+YSZ | Ni+YSZ | Ni+YSZ | Ni+YSZ | Ni+YSZ | Ni+YSZ | Ni+YSZ | Ni+YSZ | Ni+YSZ | Ni+YSZ | Ni+YSZ | Ni+YSZ | Ni+YSZ | Ni+YSZ |
| | electrode | sition | | | | | | | | | | | | | | |
| | Thickness [mm] | | 0.45 | 0.45 | 0.45 | 0.45 | 0.45 | 0.45 | 0.45 | 0.45 | 0.45 | 0.45 | 0.45 | 0.45 | 0.45 | 0.45 |
| Second | Second | Number | 0 | 0 | 0 | 0 | 0 | 0 | 0 | 0 | 0 | 0 | 0 | 0 | 0 | 0 |
| current | through | of holes | | | | | | | | | | | | | | |
| collector | hole | {(Third | — | — | — | — | — | — | — | — | — | — | — | — | — | — |
| | | width) + | | | | | | | | | | | | | | |
| | | (Fourth | | | | | | | | | | | | | | |
| | | width)}/2 | | | | | | | | | | | | | | |
| | | [mm] | | | | | | | | | | | | | | |
| | | Third | — | — | — | — | — | — | — | — | — | — | — | — | — | — |
| | | interval | | | | | | | | | | | | | | |
| | | [mm] | | | | | | | | | | | | | | |
| | | Fourth | — | — | — | — | — | — | — | — | — | — | — | — | — | — |
| | | interval | | | | | | | | | | | | | | |
| | | [mm] | | | | | | | | | | | | | | |
| | Third aperture ratio | | 0 | 0 | 0 | 0 | 0 | 0 | 0 | 0 | 0 | 0 | 0 | 0 | 0 | 0 |
| | [%] | | | | | | | | | | | | | | | |
| | Fourth | Maximum | 0 | 0 | 0 | 0 | 0 | 0 | 0 | 0 | 0 | 0 | 0 | 0 | 0 | 0 |
| | aperture | Minimum | 0 | 0 | 0 | 0 | 0 | 0 | 0 | 0 | 0 | 0 | 0 | 0 | 0 | 0 |
| | ratio [%] | | | | | | | | | | | | | | | |

| | | | | | | | | | | | | | | | |
|---|---|---|---|---|---|---|---|---|---|---|---|---|---|---|---|
| | Average pore diameter | 450 | 450 | 450 | 450 | 450 | 450 | 450 | 450 | 450 | 450 | 450 | 450 | 450 | 450 |
| | of second metal | | | | | | | | | | | | | | |
| | porous body [μm] | | | | | | | | | | | | | | |
| | Composition | Ni | Ni | Ni | Ni | Ni | Ni | Ni | Ni | Ni | Ni | Ni | Ni | Ni | Ni |
| | Thickness [mm] | 0.5 | 0.5 | 0.5 | 0.5 | 0.5 | 0.5 | 0.5 | 0.5 | 0.5 | 0.5 | 0.5 | 0.5 | 0.5 | 0.5 |
| Second | Groove | Present | Present | Present | Present | Present | Present | Present | Present | Present | Present | Present | Present | Present | Present |
| inter- | Composition | FeCr | FeCr | FeCr | FeCr | FeCr | FeCr | FeCr | FeCr | FeCr | FeCr | FeCr | FeCr | FeCr | FeCr |
| connector | Thickness [mm] | 0.5 | 0.5 | 0.5 | 0.5 | 0.5 | 0.5 | 0.5 | 0.5 | 0.5 | 0.5 | 0.5 | 0.5 | 0.5 | 0.5 |

| | | | | | | | | | | | | | | |
|---|---|---|---|---|---|---|---|---|---|---|---|---|---|---|
| Thickness of solid | 2.45 | 2.05 | 2.05 | 2.05 | 2.05 | 2.05 | 2.05 | 2.05 | 2.05 | 2.05 | 2.05 | 2.05 | 2.05 | 2.05 |
| electrochemical device [mm] | | | | | | | | | | | | | | |
| Pressure loss | 50 | 100 | 56 | 62 | 71 | 80 | 92 | 96 | 20 | 49 | 45 | 60 | 75 | 40 |
| Maximum power density | 400 | 80 | 351 | 342 | 336 | 320 | 300 | 120 | 250 | 345 | 319 | 343 | 190 | 223 |
| [mW/cm²] | | | | | | | | | | | | | | |
| Maximum power density per unit | 163 | 39 | 171 | 167 | 164 | 156 | 146 | 59 | 122 | 168 | 156 | 167 | 93 | 109 |
| thickness [mW/cm²/mm] | | | | | | | | | | | | | | |

### <<Evaluation of Characteristics of Solid Electrochemical Device>>

### <Thickness of Cell>

A thickness of the cell of the solid electrochemical device for each sample was measured by the method described in Embodiment 1. The obtained results are listed in the “thickness [mm]” column of the “Cell” column in Table 1.

### <Thickness of Solid Electrochemical Device>

For the solid electrochemical device of each sample, a thickness of the solid electrochemical device for each sample was determined by the method described in Embodiment 1. The obtained results are listed in the “Thickness of solid electrochemical device [mm]” column in Table 1. When the “Thickness of solid electrochemical device [mm]” being 2.10 mm or less, it means that the solid electrochemical device is compact. Table 1 shows that the solid electrochemical devices for sample 1 to sample 12 and sample 102 are significantly more compact than the solid electrochemical device for sample 101.

### <Pressure Loss>

For the solid electrochemical device of each sample, a degree of pressure loss of the solid electrochemical device for each of sample 1 to sample 12 and sample 101 was determined by the following method, when the degree of pressure loss of the solid electrochemical device for sample 102 was set to 100. That is, air gas was allowed to flow from a central portion of the first current collector at a rate of 0.5 L/min, and a pressure at the central portion when the air gas radially flowed from the central portion was measured using a digital differential pressure gauge testo512 manufactured by Testo K.K. The degree of pressure loss corresponding to a pressure for the sample 102 was set to 100, and the degree of pressure loss corresponding to a pressure for each sample was determined as a relative value. The obtained results are listed in the “Pressure loss” column in Table 1. When the degree of pressure loss of the solid electrochemical device for sample 102 is set to 100, the degree of pressure loss of the solid electrochemical device for each sample being less than 100 means that the solid electrochemical device is excellent in suppressing pressure loss. Table 1 shows that the solid electrochemical devices for sample 1 to sample 12 are significantly superior to the solid electrochemical device for sample 102 in terms of suppression of pressure loss.

### <Maximum Power Density and Maximum Power Density per Unit Thickness of Solid Electrochemical Device>

A maximum power density was determined by setting an operating temperature to 750° C., flowing a fuel gas of hydrogen to an anode of the solid electrochemical device for each sample at a rate of 0.2 L/min, and flowing air to a cathode at a rate of 0.3 L/min. In the solid electrochemical device for each sample, the first current collector was used as a cathode, and the second current collector was used as an anode. The obtained results are listed in the “Maximum power density [mW/cm²]” column in Table 1.

Next, for the solid electrochemical device of each sample, a maximum power density per unit thickness was determined by dividing the maximum power density of the solid electrochemical device by the thickness of the solid electrochemical device. The results obtained are listed in the column “Maximum power density per unit thickness [mW/cm²/mm]” in Table 1.

Here, when the maximum power density is “100 mW/cm² or more” and the maximum power density per unit thickness is “50 mW/cm²/mm or more”, it means that the solid electrochemical device is excellent in terms of power density.

Comparing the power densities of the solid electrochemical devices for sample 1 to sample 12 and sample 102, which can be miniaturized, the solid electrochemical devices for sample 1 to sample 12 have a significantly higher maximum power density and a significantly higher maximum power density per unit thickness than the solid electrochemical device for sample 102. That is, the solid electrochemical devices for sample 1 to sample 12 can have a significantly excellent power density compared to the solid electrochemical device for sample 102.

As described above, the solid electrochemical devices for sample 1 to sample 12 were found to be compact, excellent in “suppression of pressure loss”, and excellent in “power density”.

Although the first current collector is used as an air electrode current collector in all of the samples, it is considered that the same effects can be obtained even when the first current collector is used as a fuel electrode current collector instead of the air electrode current collector. This is because it is a technical common sense of those skilled in the art that when the power density is improved by improving the diffusibility of air flowing in from a side of the solid electrochemical device on which the air electrode is present, the power density is also improved by improving the diffusibility of hydrogen gas flowing in from a side of the solid electrochemical device on which the fuel electrode is present.

Although the embodiments and examples of the present invention have been described above, it is originally intended to combine the configurations of the above-described embodiments and examples as appropriate.

It should be understood that the embodiments disclosed herein are illustrative in all aspects and should not be recognized as being restrictive. The scope of the present invention is defined by the scope of the claims rather than the above description, and is intended to embrace all the modifications within the meaning and range of equivalency of the claims.

### REFERENCE SIGNS LIST

11 solid electrolyte
111 first main surface
112 second main surface
12 first electrode
121 third main surface
122 fourth main surface
13 second electrode
131 eighth main surface
132 ninth main surface
20 first current collector
201 fifth main surface
202 sixth main surface
203 first region
21 first through hole
211 first width
212 second width
30 second current collector
301 tenth main surface
302 eleventh main surface
31 second through hole
311 third width
40 first interconnector
401 seventh main surface
50 second interconnector
501 twelfth main surface
100 solid electrochemical device
101 thirteenth main surface
102 fourteenth main surface

1. A solid electrochemical device comprising:
a solid electrolyte having a first main surface and a second main surface that is a surface opposite to the first main surface;
a first electrode having a third main surface and a fourth main surface that is a surface opposite to the third main surface, the first electrode being provided such that the third main surface faces the first main surface;
a first current collector having a fifth main surface and a sixth main surface that is a surface opposite to the fifth main surface, the first current collector being provided such that the fifth main surface faces the fourth main surface; and
a first interconnector having a seventh main surface, the first interconnector being provided such that the seventh main surface faces the sixth main surface,
wherein the seventh main surface of the first interconnector is a flat surface,
wherein the first current collector is formed of a first metal porous body having a three-dimensional network structure, and
wherein a plurality of first through holes are formed in the fifth main surface, the plurality of first through holes extending along a first direction from the fifth main surface toward the sixth main surface.

2. The solid electrochemical device according to claim 1,
wherein, in plan view of the fifth main surface, the first through holes each have a first width along a second direction orthogonal to the first direction and each have a second width along a third direction orthogonal to the first direction and the second direction, and
wherein an average value of the first width and the second width is 2 mm to 20 mm.

3. The solid electrochemical device according to claim 1 or claim 2,
wherein a first aperture ratio that is a percentage of a total area of the first through holes relative to an area of the fifth main surface is 2.0% to 35%.

4. The solid electrochemical device according to claim 1,
wherein, in each of nine first regions set by equally dividing the fifth main surface into nine parts based on an area criterion, a second aperture ratio that is a percentage of a total area of the first through holes in each of the first regions relative to an area of each of the first regions is 2.0% to 35%.

5. The solid electrochemical device according to claim 1,
wherein the first metal porous body is a nickel-cobalt metal porous body.

6. The solid electrochemical device according to claim 1,
wherein the first metal porous body is a nickel metal porous body.

7. The solid electrochemical device according to claim 1,
wherein the first metal porous body is a nickel-tin metal porous body.

8. The solid electrochemical device according to claim 1, further comprising:
a second electrode having an eighth main surface and a ninth main surface that is a surface opposite to the eighth main surface, the second electrode being provided such that the eighth main surface faces the second main surface;
a second current collector having a tenth main surface and an eleventh main surface that is a surface opposite to the tenth main surface, the second current collector being provided such that the tenth main surface faces the ninth main surface; and
a second interconnector having a twelfth main surface, the second interconnector being provided such that the twelfth main surface faces the eleventh main surface,
wherein the twelfth main surface of the second interconnector is a flat surface,
wherein the second current collector is formed of a second metal porous body having a three-dimensional network structure, and
wherein a plurality of second through holes are formed in the tenth main surface, the plurality of second through holes extending along a fourth direction from the tenth main surface toward the eleventh main surface.

9. The solid electrochemical device according to claim 8,
wherein, in plan view of the tenth main surface, the second through holes each have a third width along a fifth direction orthogonal to the fourth direction and each have a fourth width along a sixth direction orthogonal to the fourth direction and the fifth direction, and
wherein an average value of the third width and the fourth width is 2 mm to 20 mm.

10. The solid electrochemical device according to claim 8,
wherein a third aperture ratio that is a percentage of a total area of the second through holes relative to an area of the tenth main surface is 2.0% to 35%.

11. The solid electrochemical device according to claim 8,
wherein, in each of nine second regions set by equally dividing the tenth main surface into nine parts based on an area criterion, a fourth aperture ratio that is a percentage of a total area of the second through holes in each of the second regions relative to an area of each of the second regions is 2.0% to 35%.

12. The solid electrochemical device according to claim 8,
wherein the second metal porous body is a nickel-cobalt metal porous body.

13. The solid electrochemical device according to claim 8,
wherein the second metal porous body is a nickel metal porous body.

14. The solid electrochemical device according to claim 8,
wherein the second metal porous body is a nickel-tin metal porous body.
